(19) United States
(12) Patent Application Publication
(10) Pub. No.: US 2004/0160447 A1
(43) Pub. Date: Aug. 19, 2004

(54) Simple method to minimize memory usage and/or power consumption for dispaly controller circuits

(76) Inventors: Denis Beaudoin, Surrey (CA); Barinder Singh Rai, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/368,117

(22) Filed: Feb. 18, 2003

(51) Int. Cl. G09G 5/39; G06F 13/00

(52) U.S. Cl. 345/531; 345/538

(57) ABSTRACT

A display controller circuit for controlling a display memory having a plurality of memory locations, each memory location having a memory depth. Pixel data having a pixel data depth and a repeat count having a repeat count depth may be stored in each memory location of the display memory. The repeat count represents the number of times the pixel data is to be repeated for display on the external display device. The display controller circuit may be a “fetch inhibiting” display controller or a “memory saving” display controller. A method for controlling memory having a plurality of memory locations, each memory location having a memory depth, the memory depth divided into a data depth for storing data and an excess depth for storing a repeat count.

### BACKGROUND OF INVENTION

The present invention is directed to a simple method to minimize memory usage and/or power consumption for display controller circuits and, more specifically to a method that uses excess, additional, or extra bits as a “repeat count” to reduce fetches, thereby minimizing memory usage and/or power consumption for display controller circuits.

As shown in FIG. 1, static digital images are stored as an array of. pixels 16 to represent a frame on a display 18. Each pixel 16 has a given amount of pixel information associated with it including its specific color. Many display circuits use 32-bit memory (each line or location of memory having 32 bits) to store display or video data that can be organized as 1, 2, 4, 8, 16 bit(s) per pixel information, where the red, green and blue color information is divided up into that pixel depth. Since most of these pixel depths align precisely to either 16 or 32-bit memory, the memory usage or efficiency was optimized.

RGB (Red/Green/Blue) is a color pixel control model that uses the three individual primary colors (red, green, and blue) to form each of the pixels of a color image. The RGB pixel control model is based on the principle that these three primary colors of light can be mixed together in various proportions to produce all the other colors. In a color cathode ray tube (CRT) display 18, three electron guns direct these three colors of light at the screen in separate beams. Traditional liquid crystal displays (LCD) use 16-bit pixels where the bits are split as 5 bits for red, 6 bits for green, and 5 bits for blue respectively. Newer displays and their associated controller chips use 24-bit pixels to take advantage of a finer color resolution for each of the RGB pixel control model by designating eight bits to specify the exact red desired, eight bits to specify the exact green desired, and eight bits to specify the exact blue desired. The simplest approach to implementing or expanding existing video circuits to have the capacity to implement the 24-bit RGB pixel control model is to “waste” the remaining 8 bits in a 32-bit system.

Other pixel control models exist that designate or control pixels 16 in a display 18. For example, an HSL (Hue, Saturation, and Luminance) can be used to control the color (hue), the strength of the color, or how far it is from neutral gray (saturation), and the intensity of light reflected or transmitted by a color (luminance). The HSL pixel control model may be implemented in 24-bits. Another pixel control model that could be used to designate control for pixels 16 would be a YUV (luminance signal Y and color-difference signals U and V). The YUV pixel control model may be implemented in 24-bits. Of course, many combinations of pixel depths are possible, but they do not always make efficient use of “standard” data bus widths of 8, 16, or 32 bits per pixel. In those cases, either the extra bits are thrown away or the circuit designer must include a method to re-align the data that may have been misaligned into the memory (packed) as described below in the discussion of U.S. Pat. No. 6,271,867 to Moriarty (the “Moriarty reference”). As with the RGB pixel control model, the simplest approach to implementing or expanding existing video circuits to have the capacity to implement these alternative 24-bit pixel control model is to “waste” the remaining 8 bits in a 32-bit system.

In addition to CRT and LCD displays, other types of display presentation mechanisms (referred to as “displays 18”) include, but are not limited to, gas plasma displays, flat panel displays, computer monitors, arcade graphic displays, television screens, and other types of video displays. The number of pixels 16 available on a display 18 determines the screen resolution. For example, common display resolutions for a display 18 using the RGB pixel control model are 800×600, 640×480, 1024×760, and 1280×1024. The total number of pixels 16 is determined by multiplying the two numbers. For example, a display 18 having a resolution of 800×600 would have 800 rows of 600 pixels each for a total of 480,000 pixels. The resolution of any image is specified in DPI (dots per inch). For example, 96 dpi means 96×96 pixels (9216 pixels) for a square inch. More pixels 16 translate directly to images that are more definite. More pixels 16, however, also means more excess memory when only 24 bits of each 32 bits are used.

A computer's operating system and processing units treat the pixels 16 on a display 18 as an array of dots or lights that can be individually controlled. In an RGB pixel control model, for example, the color of each pixel 16 can be controlled by the operating system based on information and/or instructions stored in specially designated memory such as a frame buffer or video memory. The operating system allocates a small amount of memory (e.g. RAM, VRAM, SRAM, DRAM) for each pixel 16. For an RGB display 18, if 8-bits are allocated controlling for each pixel 16, the display 18 can handle up to 256 colors. As discussed above, modern displays 18 approach nearly photographic-color (“True-Color”) by allocating 24 bits per pixel.

A video adapter (also called a display adapter or video board) provides digital-to analog conversion, video memory, and display controller circuits (a video controller) to control images sent to the displays 18. A common video display standard used by displays and video adapters is a Video Graphics Array (VGA) video standard. Other exemplary types of video display standards include SVGA, XGA, CIF, and QCIF. Regardless of which video display standard is used, the standards describe how data is passed between the computer and the display 18 and then displayed thereon.

For example, as shown in FIG. 2, when images are sent to the display 18, they may first be read 20 by the processor as data from some form of main (non-video) memory and then written 22 to the video memory. This process of reading 20 and writing 22 from main memory to video memory can also be referred to as fetching 24a. Sometimes information is written directly to video memory without being transferred or fetched from a main memory. Regardless of how the information came to the video memory, information from video memory may be converted by a digital-to-analog converter 26 from digital data into analog signals that are then sent 28 to the displays 18. Refreshing steps, such as those shown in FIG. 3, are used in refreshing the displays from the video memory. In the refreshing process, data is fetched 24b (or simply read) from the video memory and then converted 26 and displayed. Some systems refresh their display at 60-100 times per second (refresh rates of 60 Hz to 100 Hz). It should be noted that other refresh rates are possible and commonly used. In many display standards, the process of fetching 24a, 24b, converting 26, and displaying 28 is performed for each pixel 16. Most forms of video memory are dual-ported, which means that while the processor is writing a new image to video memory, the display 18 is reading from video memory to refresh its current display content.

It should be noted that the video adapter, digital-to analog converter, video memory, and display controller circuits may be integrated in a single integrated circuit, may be implemented in one or more integrated circuit cards, may be integrated in a computer, may be implemented in a display monitor, or may be implemented as separate components.

Within a static digital image, adjacent images are often similar. For example, as shown in FIG. 4, the pixels 36 in the top line of the frame 30a are all ON (white). In addition, the left side of the next line of pixels are all ON (white). In a digital image of a photo, this may be seen as the sky having the same color. In a digital image of text, most of the page would be white. When adjacent or sequential pixels within a frame have a similar state or color, the state or color can be said to be “repeated” between adjacent pixels 16.

Non-static digital images (e.g. a video clip or a television program) are actually a series of static digital image frames 30a, 30b, 30c such as those shown in FIG. 4. In many types of non-static digital images, the images of sequential static digital image frames do not change completely. As shown in FIG. 4, a pixel 32 may remain ON (white) for a series of frames 30a, 30b, 30c, a pixel 34 may remain OFF (black) for a series of frames 30a, 30b, 30c, or a pixel 36, 38 may switch between ON (white) and OFF (black) for a series of frames 30a, 30b, 30c. Similarly, the color may remain constant for a series of frames or may change for a series of frames. For example, if the non-static digital image is of a person walking from one side of a room to the other side of the room, the background (e.g. the room) may not change at all. Another example is a display of a textual document where only the pixels 16 where the user is typing are changing, but the remainder of the document remains the same. When a pixel's state or color remains constant for a series of frames, the state or color of that pixel 16 can be said to be “repeated” between the sequential static digital image frames.

There are references that exist that suggest means for taking advantage of the excess or remaining 8 bits in a 32-bits system. For example, in the Moriarty reference, Moriarty recognized that the twenty-four bits that make-up a true color pixel was being addressed thirty-two bits at a time. Moriarty seeks to take advantage of the additional or extra bits by using a technique that efficiently packs eight twenty-four bit pixels into three quad words of video memory. The Moriarty system fully utilizes video memory by dividing two of the twenty-four bit pixels into constituent eight-bits representations of each of three primary pixel colors. Two undivided pixels and two of the constituent eight-bits representations of the divided pixels are stored within each of the quad words.

### BRIEF SUMMARY OF THE INVENTION

The present invention is directed to a simple method to minimize memory usage and/or power consumption for display controller circuits by using excess, additional, or extra bits (e.g. the wasted 8 bits in a 32-bits system) as a “repeat count” to indicate that the specific pixel will be repeated. This method reduces fetches, thereby minimizing memory usage and/or power consumption for display controller circuits.

More specifically, the present invention, in one preferred embodiment, is directed to a display controller circuit for controlling a display memory having a plurality of memory locations, each memory location having a memory depth. Pixel data having a pixel data depth and a repeat count having a repeat count depth may be stored in each memory location of the display memory. The repeat count represents the number of times the pixel data is to be repeated for display on the external display device. The display controller circuit may be a “fetch inhibiting” display controller or a “memory saving” display controller.

Another preferred embodiment of the present invention is a memory control method in which the first step is providing a memory having a plurality of memory locations, each memory location having a memory depth, the memory depth divided into a data depth and an excess depth. At least one data having the data depth may be stored in the data depth of the memory. At least one repeat count may be stored in at least part of the excess depth of the memory. The method also includes the steps of fetching the data and an associated repeat count from one of the memory locations and displaying the data on a display. The step of displaying the data on a display is then repeated a number of times equal to the repeat count.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a simplified display having an array of pixels 16 to represent a frame.

FIG. 2 is a simplified flow chart the process of fetching, converting, and displaying data from main memory to a display.

FIG. 3 is a simplified flow chart the process of fetching, converting, and displaying data for refreshing a display.

FIG. 4 is a series of simplified static digital image frames.

FIG. 5 is a simplified flow chart depicting an exemplary “fetch inhibiting” process for fetching pixel data from main memory to video memory implemented for static digital images.

FIG. 6 is a simplified flow chart depicting an exemplary “memory saving” process for fetching pixel data from main memory to video memory implemented for static digital images.

FIG. 7 is a simplified flow chart depicting an exemplary “fetch inhibiting” process for fetching pixel data from video memory to refresh a display implemented for static digital images.

FIG. 8 is a simplified flow chart depicting an exemplary “memory saving” process for fetching pixel data from video memory to refresh a display implemented for static digital images.

FIG. 9 is a simplified flow chart depicting an exemplary process of the present invention implemented for non-static digital images.

### DETAILED DESCRIPTION OF THE INVENTION

The present invention is directed to a simple method to minimize memory usage and/or power consumption for display controller circuits by using excess, additional, or extra bits (e.g. the wasted 8 bits in a 32-bits system) as a “repeat count” to indicate that characteristics of the specific pixel 16 will be repeated. This method reduces fetches, thereby minimizing memory usage and/or power consumption for display controller circuits. The present invention may be implemented for fetches that occur from main (non-video) memory to be written to the video memory and/or from the frame buffer (video memory) to be displayed (as a refresh).

It should be noted that the concepts described herein can apply to any pixel depth, but is most attractive in configurations (such as a 24-bits pixel control model) that have “excess” bits (such as in a 32-bits memory system). For example, if a 16-bits memory is used to store display or video data, but only 8 bits are needed to define the individual pixels 16, then the remaining “excess” 8 bits could be used to implement the present invention. For simplicity, throughout this specification, the exemplary 24 bits in a 32-bits system will be used, but it is meant to be understood that the concepts described herein can apply to any pixel depths that have “excess” bits.

The present invention is realized through the recognition of four principles. First, data having a data depth that is less than memory depth leads to excess memory. Second, storing data utilizes valuable memory. Third, fetching data utilizes valuable power (which translates into unwanted heat and battery drain). And fourth, data is often repeated.

Data having a data depth that is less than memory depth leads to excess memory. An example of this principle is that many display circuits use a 32-bits memory depth to store display or video data. Some pixel control models, however, only require a 24-bits memory depth to control each pixel. The simplest approach to implementing or expanding existing video circuits to have the capacity to implement the 24-bits pixel control model is to “waste” the remaining 8 bits in a 32-bits system.

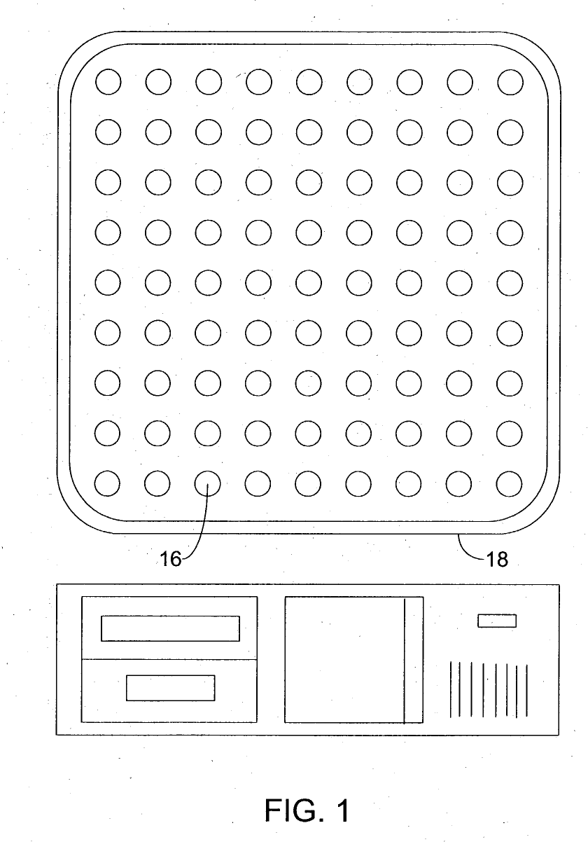

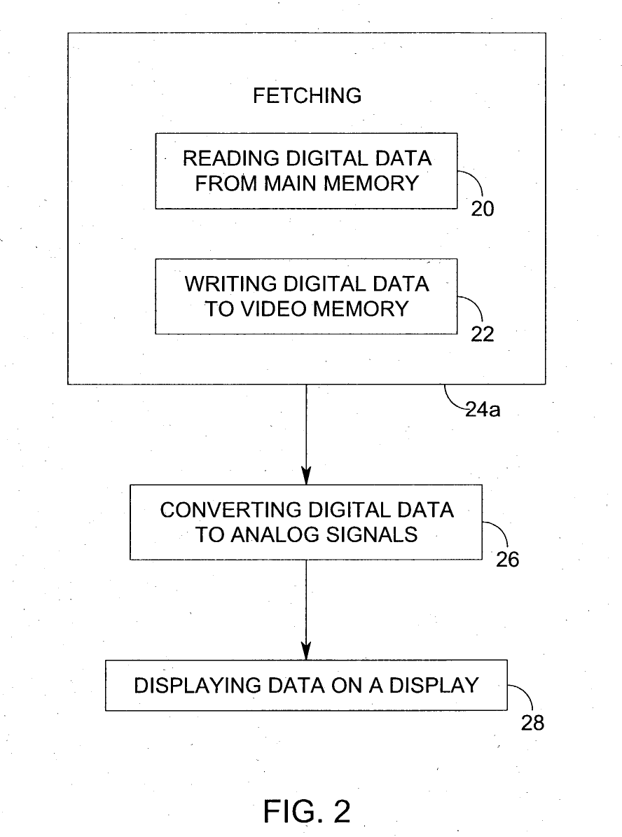

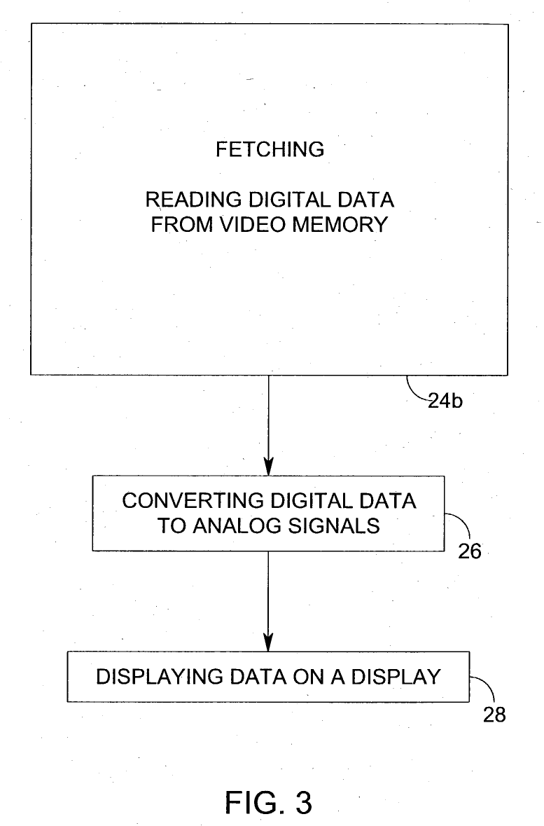

Storing data and fetching data utilizes valuable memory and power. For example, as set forth in the background, to display an image on a video display 18, as shown in FIG. 2, the image data is fetched 24a by being read 20 by the processor as data from some form of main (non-video) memory and then written 22 to the video memory or frame buffer. Fetching 24b for the purposes of refreshing a display (FIG. 3) occurs at very quick speeds (and very often). In either case, fetching 24a, 24b requires valuable computer resources. Once the data has been fetched, a digital-to-analog converter converts 26 the digital data into analog signals that are then sent 28 to the displays 18. It should be noted that after image data is fetched 24a as shown in FIG. 2, it may be fetched 24b for purposes of refreshing a display as shown in FIG. 1. On the other hand, the processes shown in FIGS. 1 and 2 may be used independently. In many display standards, the process of fetching 24a, 24b, converting 26, and displaying 28 is performed for each pixel 16. More pixels 16 translate directly to images that are more definite. More pixels 16, however, also mean more excess memory and more fetches.

Data is often repeated. For example, in a static digital image when adjacent or sequential pixels within a frame have a similar state or color, the state or color can be said to be “repeated” between adjacent pixels 16. Similarly, data is also repeated in non-static digital images. For example, data is repeated in non-static digital images when a pixel's state or color remains constant for a series of frames, the state or color of that pixel 16 can be said to be “repeated” between the sequential static digital image frames.

The present invention uses the extra bits of excess memory to store a “repeat count.” If the “repeat count” is zero (0), then the system would display the pixel 16 only once (no repeats) in the appropriate position as it normally would, using its normal procedure. On the other hand, if the repeat count is anything but zero (0), then the pixel 16 to be displayed again in the next adjacent position on the frame (e.g. if the repeat count is 2, then there would be two repeats, for a total of three displays). If the next pixel 16 is identical, a memory fetch would not be required thus saving power (and in the second embodiment, also saving memory requirement). Specifically, a non-zero repeat count would indicate the number of times a given pixel 16 is to be repeated on the frame as it is refreshed or scanned.

Another way to describe the repeat count is that it is equal to 1+n times the data is to be used. The data would be used the number of times equal to the repeat count plus once for the first fetch. If the repeat count is zero (0), the data would be used (for example, displayed) one (1) time. If the repeat count is five (5), the data would be used (for example, displayed) six (6) times.

The following table is an exemplary 32-bits memory table:

| | 8-bit | | | |
|---|---|---|---|---|
| | repeat | 8-bit | 8-bit | 8-bit |
| Address | count | red | green | blue |
| . | . | . | . | . |
| . | . | . | . | . |
| . | . | . | . | . |
| 0010H | RC₅ | R₅ | G₅ | B₅ |
| 000CH | RC₄ | R₄ | G₄ | B₄ |
| 0008H | RC₃ | R₃ | G₃ | B₃ |
| 0004H | RC₂ | R₂ | G₂ | B₂ |
| 0000 | Rep Cnt₁ | Red₁ | Green₁ | Blue₁ |

In a first, “fetch inhibiting” preferred embodiment of the present invention, data values are stored normally (RGB) and no attempt is made at trying to save memory. The “repeat count” RC₁, RC₂, RC₃, is used to avoid memory fetches of subsequent locations where the RC is non-zero indicating the next “n” pixels are actually identical to the one that was just fetched. In this embodiment, the RC Value indicates how many of the next pixels are identical. The address counter increments but the memory fetch is inhibited. This increases the speed of the system. This method allows the display host to load images normally without worrying about the RC. As the RC Values get loaded (while the image is being displayed) the power consumption is reduced.

In a second, “memory saving” preferred embodiment of the present invention, data values don't get loaded in memory if the previous pixel is identical and contains a non-zero RC Value and the address counter does not increment for every pixel (as was done in the first embodiment). Instead, the pixel 16 is repeated as specified above and the next memory fetch takes place once the pixel 16 has been repeated the appropriate number of times. At that point, the address increments and the memory fetch takes place. This reduces power consumption and also memory usage (some basic image compression). It also tends to increase the speed of the system.

It should be noted that a post-processing hardware block could be devised to load the RC Values for the CPU. It would go through memory (once the image is loaded by the host CPU) and figure out the RC values.

It should be noted that the present invention may be implemented selectively such that without a predetermined signal or specific activation, the present invention would not be activated. This would allow devices incorporating the present invention to function with software and/or hardware not specifically designed to implement the present invention.

It should be noted that the present invention may be implemented with most types of display presentation mechanisms 18 including, but are not limited to, CRT displays, LCDs, gas plasma displays, flat panel displays, computer monitors, television screens, and other types of video displays. This would be true even if the type of units the display is divided into were something other than pixels. For example, if a display were divided into lines, screens, or other unit, the present invention could be adapted to accommodate the unit.

### EXAMPLES

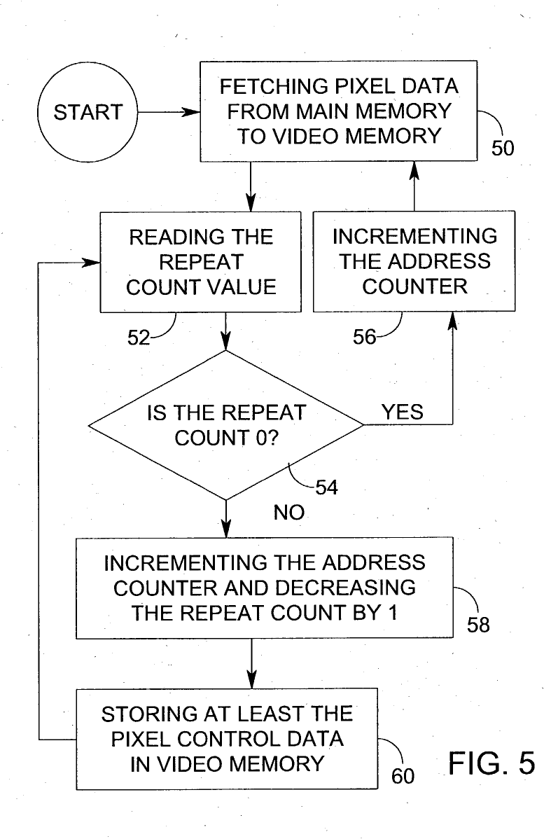

The exemplary methods depicted in FIGS. 5-9 are exemplary implementations of various embodiments of the present invention.

FIG. 5 is a simplified flowchart depicting the “fetch inhibiting” preferred embodiment of the present invention fetching pixel data from main memory to video memory implemented for static digital images. Pixel data (including 24-bits for a pixel control model and 8 bits for an RC Value) for a first pixel of an image is fetched from main memory to video memory 50. The 8-bits RC Value is read by the processor 52. The RC Value indicates how many of the next pixels are identical. Accordingly, if the repeat count is zero (0) 54, then the system would increment an address counter 56 and perform a memory fetch for the next pixel 50. On the other hand, if the repeat count is anything but zero (0) 54, for the number of times equal to the repeat count, the address counter would be incremented 58, and the 24-bits for the pixel control model would be stored in the video memory 60. From the video memory, a digital-to-analog converter converts 26 the digital data into analog signals that are then sent 28 to the display 18 using standard methods for displaying from video memory or methods such as those discussed below.

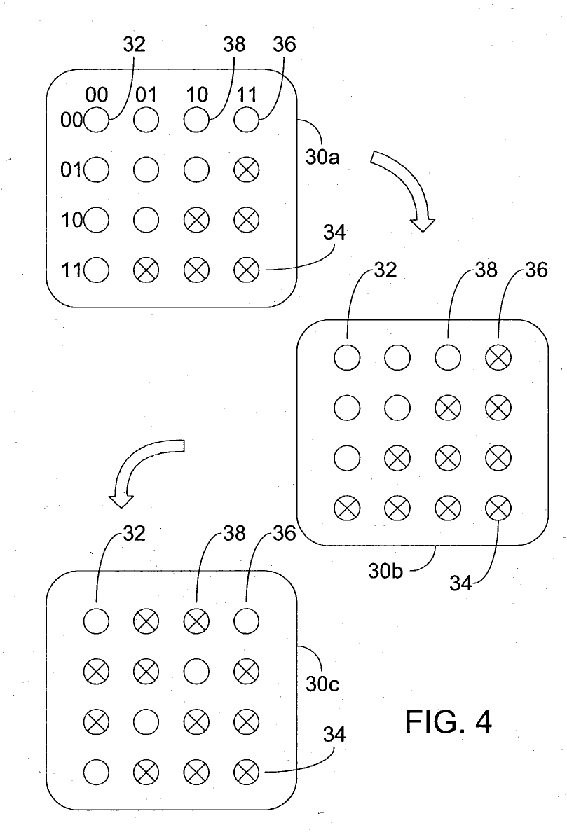

A simplified version of memory after the “fetch inhibiting” method of FIG. 5 of implementing the present invention for frame 30a as shown in FIG. 4 could be represented as follows.

TABLE 1

| | 8-bit | | | |
|---|---|---|---|---|
| | repeat | 8-bit | 8-bit | 8-bit |
| Address | count | red | Green | blue |
| 0000 | 6 | ON | ON | ON |
| 0001 | * | ON | ON | ON |
| 0010 | * | ON | ON | ON |
| 0011 | * | ON | ON | ON |
| 0100 | * | ON | ON | ON |
| 0101 | * | ON | ON | ON |
| 0110 | * | ON | ON | ON |
| 0111 | 0 | OFF | OFF | OFF |
| 1000 | 1 | ON | ON | ON |
| 1001 | * | ON | ON | ON |
| 1010 | 1 | OFF | OFF | OFF |
| 1011 | * | OFF | OFF | OFF |
| 1100 | 0 | ON | ON | ON |
| 1101 | 2 | OFF | OFF | OFF |
| 1110 | * | OFF | OFF | OFF |
| 1111 | * | OFF | OFF | OFF |

A “*”, in the Table 1 above, indicates that it is not necessary to store a value.

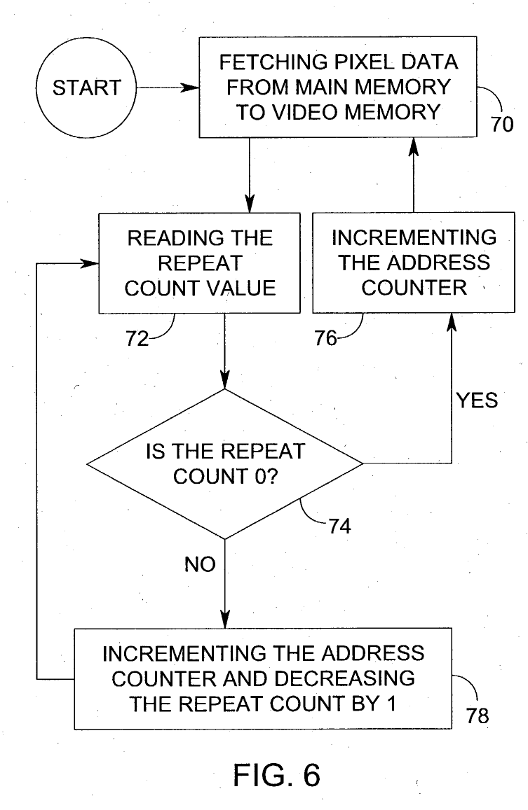

FIG. 6 is a simplified flowchart depicting the second, “memory saving ” preferred embodiment of the present invention fetching pixel data from main memory to video memory implemented for static digital images. Pixel data (including 24-bits for a pixel control model and 8 bits for an RC Value) for a first pixel of an image is fetched from main memory to video memory 70. The 8-bits RC Value is read by the processor 72. The RC Value indicates how many of the next pixels are identical. Accordingly, if the repeat count is zero (0) 74, then the system would increment an address counter 76 and perform a memory fetch for the next pixel 70. On the other hand, if the repeat count is anything but zero (0) 74, for the number of times equal to the repeat count, the address counter would be incremented 78. (Alternatively, the address counter could be incremented by the number represented by the repeat count so that the program would not have to loop more than once.) It would not be necessary to store the 24-bits for the pixel control model in the video memory. From the video memory, a digital-to-analog converter converts 26 the digital data into analog signals that are then sent 28 to the display 18 using methods for displaying from video memory as discussed below.

A simplified version of memory after the “fetch inhibiting” method of FIG. 6 of implementing the present invention for frame 30a as shown in FIG. 4 could be represented as follows.

TABLE 2

| | 8-bit | | | |
|---|---|---|---|---|
| | repeat | 8-bit | 8-bit | 8-bit |
| Address | count | red | Green | blue |
| 0000 | 6 | ON | ON | ON |
| 0001 | * | * | * | * |
| 0010 | * | * | * | * |
| 0011 | * | * | * | * |
| 0100 | * | * | * | * |
| 0101 | * | * | * | * |
| 0110 | * | * | * | * |
| 0111 | 0 | OFF | OFF | OFF |
| 1000 | 1 | ON | ON | ON |
| 1001 | * | * | * | * |
| 1010 | 1 | OFF | OFF | OFF |
| 1011 | * | * | * | * |
| 1100 | 0 | ON | ON | ON |
| 1101 | 2 | OFF | OFF | OFF |
| 1110 | * | * | * | * |
| 1111 | * | * | * | * |

A “*”, in the Table 2 above, indicates that it is not necessary to store a value.

An alternative simplified version of memory after the “memory saving” preferred embodiment of implementing the present invention for frame 30a as shown in FIG. 4 could be represented as follows.

TABLE 3

| | 8-bit | | | |
|---|---|---|---|---|
| | repeat | 8-bit | 8-bit | 8-bit |
| Address | count | red | Green | blue |
| 0000 | 6 | ON | ON | ON |
| 0001 | 0 | OFF | OFF | OFF |
| 0010 | 1 | ON | ON | ON |
| 0011 | 1 | OFF | OFF | OFF |
| 0100 | 0 | ON | ON | ON |
| 0101 | 2 | OFF | OFF | OFF |

In Table 3 above, the address does not correspond to the pixel positions shown in FIG. 4, but represent traditional memory address locations. In this alternative version, the video memory would not have to be linked to the specific pixel addresses. The first 32 bits would always represent the first pixel (and the repeat count-1 pixels following the first pixel). Each subsequent 32 bits would represent the subsequent number pixels indicated by the repeat count. In this embodiment, the “address counter” would represent the 32 bits in memory. Table 3 might be fetched directly from main memory or it might be the result of a post processing hardware block cell that went through memory to determine the RC values.

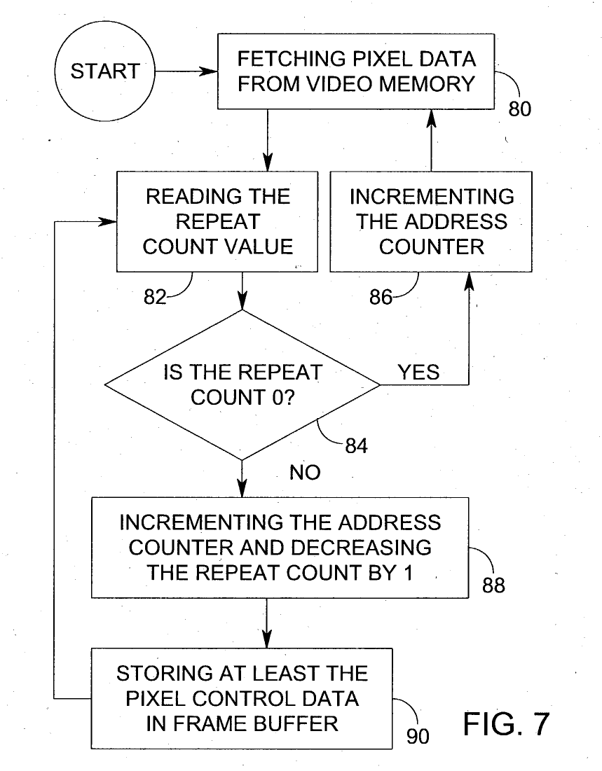

FIG. 7 is a simplified flow chart depicting an exemplary “fetch inhibiting” process for fetching pixel data from video memory to refresh a display implemented for static digital images. This embodiment could read video memory such as that shown in Tables 1-2. (FIG. 7 could read video memory such as that shown in Table 3 if it is understood that the address counter in FIG. 7 is the address counter of the frame buffer. Instead of fetching from a specific address in video memory, the next 32-bits of video memory is accessed for each fetch 80.) Pixel data (including 24-bits for a pixel control model and 8 bits for an RC Value) for a first pixel of an image is fetched from video memory 80. The 8-bit RC Value is read by the processor 82. The RC Value indicates how many of the next pixels are identical. Accordingly, if the repeat count is zero (0) 84, then the system would increment an address counter 86 and perform a memory fetch for the next pixel 80. On the other hand, if the repeat count is anything but zero (0) 84, for the number of times equal to the repeat count, the address counter would be incremented 88 and the 24-bits for the pixel control model would be stored in the frame buffer 90. From the frame buffer, a digital-to-analog converter converts the digital data into analog signals that are then sent to the display.

A simplified version of the frame buffer memory after the “fetch inhibiting” method of FIG. 7 of implementing the present invention for frame 30a as shown in FIG. 4 could be represented as follows.

TABLE 4

| | 8-bit | | | |
|---|---|---|---|---|
| | repeat | 8-bit | 8-bit | 8-bit |
| Address | count | red | Green | blue |
| 0000 | 6 | ON | ON | ON |
| 0001 | * | ON | ON | ON |
| 0010 | * | ON | ON | ON |
| 0011 | * | ON | ON | ON |
| 0100 | * | ON | ON | ON |
| 0101 | * | ON | ON | ON |
| 0110 | * | ON | ON | ON |
| 0111 | 0 | OFF | OFF | OFF |
| 1000 | 1 | ON | ON | ON |
| 1001 | * | ON | ON | ON |
| 1010 | 1 | OFF | OFF | OFF |
| 1011 | * | OFF | OFF | OFF |
| 1100 | 0 | ON | ON | ON |
| 1101 | 2 | OFF | OFF | OFF |
| 1110 | * | OFF | OFF | OFF |
| 1111 | * | OFF | OFF | OFF |

A “*” indicates that a value could be stored or not stored. This embodiment allows the host to load images (display) normally without consideration to the repeat count.

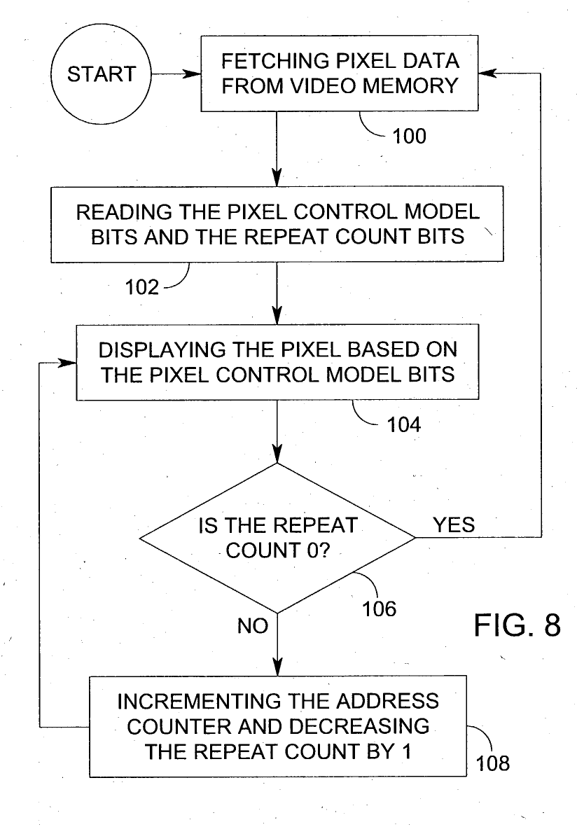

FIG. 8 is a simplified flow chart depicting an exemplary “memory saving” process for fetching pixel data from video memory to refresh a display implemented for static digital images. This embodiment could read video memory such as that shown in Tables 1-2. (FIG. 7 could read video memory such as that shown in Table 3 if it is understood that the address counter in FIG. 7 is the address counter of the frame buffer. Instead of fetching from a specific address in video memory, the next 32-bits of video memory is accessed for each fetch 100.) Pixel data (including 24-bits for a pixel control model and 8 bits for an RC Value) for a first pixel of an image is fetched from video memory 100. The pixel data and the RC Value are then read by the video processor 102. The pixel is then displayed based on the pixel control model bits 104. The RC Value indicates how many of the next pixels are identical. Accordingly, if the repeat count is zero (0) 106, then the system would read the information for the next pixel or pixels from video memory 102. On the other hand, if the repeat count is anything but zero (0) 106, for the number of times equal to the repeat count, the address counter would be incremented 108 or the system would otherwise recognize that the next pixel was to be addressed and the repeat count would be decreased by one (1) 108. The pixel is then displayed based on the pixel control model bits 104.

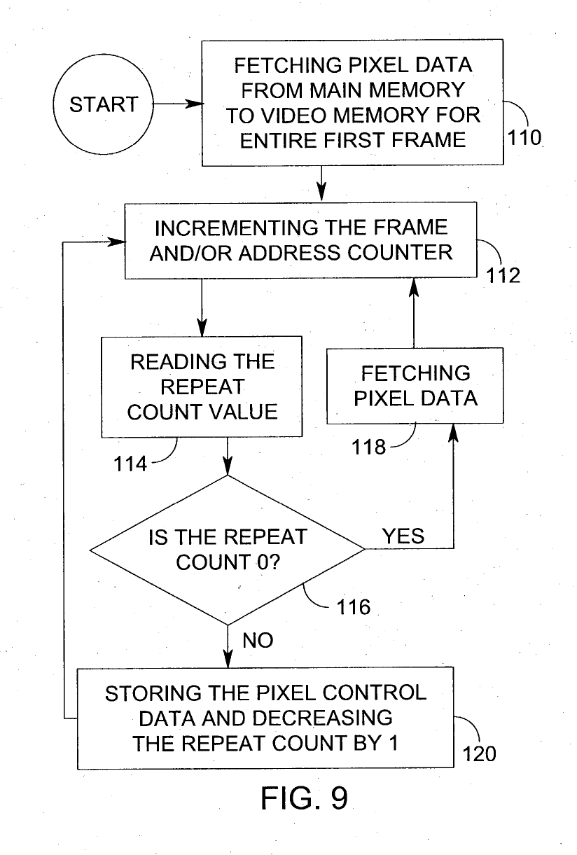

FIG. 9 is a simplified flow chart depicting an exemplary process of the present invention implemented for non-static digital images. In addition to data being repeated in static digital images, as set forth above, data is also repeated in non-static digital images. For example, data is repeated in non-static digital images when a pixel's state or color remains constant for a series of frames, the state or color of that pixel 16 can be said to be “repeated” between the sequential static digital image frames. For exemplary purposes, the series of static digital image frames 30a, 30b, 30c such as those shown in FIG. 4 will be used to discuss non-static digital images.

As FIG. 9 shows, this process would begin with the step of fetching the pixel data from main memory to video memory for the entire first frame 110. Then, for the next frame the address counter would be reset 112 and the repeat count value at the first pixel address would be read 114. If the repeat count was zero (0) 116, the pixel data (including the new repeat count) would be fetched from main memory 118 and the address counter would be incremented 112. If the repeat count was not zero (0) 116, the pixel control data would be stored and the repeat count would be decreased by one (1) 120). The address counter would then be incremented 112.

Assuming that frame 30a was the first in the series of ten (10) static digital image frames, memory for frame 30a could be represented as follows.

TABLE 5

| | 8-bit | | | |
|---|---|---|---|---|
| | repeat | 8-bit | 8-bit | 8-bit |
| Address | count | red | Green | blue |
| 0000 | 9 | ON | ON | ON |
| 0001 | 1 | ON | ON | ON |
| 0010 | 1 | ON | ON | ON |
| 0011 | 0 | ON | ON | ON |
| 0100 | 1 | ON | ON | ON |
| 0101 | 1 | ON | ON | ON |
| 0110 | 0 | ON | ON | ON |
| 0111 | 5 | OFF | OFF | OFF |
| 1000 | 1 | ON | ON | ON |
| 1001 | 0 | ON | ON | ON |
| 1010 | 9 | OFF | OFF | OFF |
| 1011 | 7 | OFF | OFF | OFF |
| 1100 | 0 | ON | ON | ON |
| 1101 | 5 | OFF | OFF | OFF |
| 1110 | 9 | OFF | OFF | OFF |
| 1111 | 9 | OFF | OFF | OFF |

As mentioned, Table 5 shows memory for the first frame in a series of ten (10) static digital image frames. This shows that the pixel at address 0000 would be ON for all ten (10) frames (the first frame, plus the nine (9) frames following). This also shows that the pixel at address 0001 would be ON for two (2) frames (the first frame, plus one (1) following). This further shows that the pixel at address 0011 would be ON only this one frame and then would change in the next frame.

Assuming that frame 30b was the second in the series of ten (10) static digital image frames, memory for frame 30b could be represented as follows.

TABLE 6

| | 8-bit | | | |
|---|---|---|---|---|
| | repeat | 8-bit | 8-bit | 8-bit |
| Address | count | red | Green | blue |
| 0000 | 8 | ON | ON | ON |
| 0001 | 0 | ON | ON | ON |
| 0010 | 0 | ON | ON | ON |
| 0011 | 0 | OFF | OFF | OFF |
| 0100 | 0 | ON | ON | ON |
| 0101 | 0 | ON | ON | ON |
| 0110 | 0 | OFF | OFF | OFF |
| 0111 | 4 | OFF | OFF | OFF |
| 1000 | 0 | ON | ON | ON |
| 1001 | 0 | OFF | OFF | OFF |
| 1010 | 8 | OFF | OFF | OFF |
| 1011 | 6 | OFF | OFF | OFF |
| 1100 | 0 | OFF | OFF | OFF |
| 1101 | 4 | OFF | OFF | OFF |
| 1110 | 8 | OFF | OFF | OFF |
| 1111 | 8 | OFF | OFF | OFF |

As mentioned, Table 6 shows memory for the second frame in a series of ten (10) static digital image frames. This shows that the pixel at address 0000 has remained ON and will remain ON for the following eight (8) frames. Similarly, the pixel at address 0001 has remained ON, but will change in the next frame. The pixel at address 0011 would be OFF only this one frame and then would change in the next frame.

Assuming that frame 30c was the third in the series of ten (10) static digital image frames, memory for frame 30c could be represented as follows.

TABLE 7

| | 8-bit | | | |
|---|---|---|---|---|
| | repeat | 8-bit | 8-bit | 8-bit |
| Address | count | red | Green | blue |
| 0000 | 7 | ON | ON | ON |
| 0001 | 3 | OFF | OFF | OFF |
| 0010 | 1 | OFF | OFF | OFF |
| 0011 | 7 | ON | ON | ON |
| 0100 | 7 | OFF | OFF | OFF |
| 0101 | 4 | OFF | OFF | OFF |
| 0110 | 0 | ON | ON | ON |
| 0111 | 3 | OFF | OFF | OFF |
| 1000 | 1 | OFF | OFF | OFF |
| 1001 | 0 | ON | ON | ON |
| 1010 | 7 | OFF | OFF | OFF |
| 1011 | 5 | OFF | OFF | OFF |
| 1100 | 5 | ON | ON | ON |
| 1101 | 3 | OFF | OFF | OFF |
| 1110 | 7 | OFF | OFF | OFF |
| 1111 | 7 | OFF | OFF | OFF |

As mentioned, Table 7 shows memory for the third frame in a series of ten (10) static digital image frames. This shows that the pixel at address 0000 has remained ON and will remain ON for the following seven (7) frames. The pixel at address 0001 has changed to OFF and will remain OFF for the next three (3) frames. The pixel at 0011 has changed to ON and will remain ON for the following seven (7) frames.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A display controller circuit for use with an external system, said external system including an external processing device and an external display device, said display controller circuit comprising:
(a) display memory having a plurality of memory locations, each memory location having a memory depth;
(b) pixel data having a pixel data depth, said pixel data depth being less than said memory depth, said pixel data stored in said display memory;
(c) repeat count having a repeat count depth, said repeat count depth being less than said memory depth, said repeat count stored in said display memory;
(d) wherein said repeat count represents the number of times said pixel data is to be repeated for display on said external display device.

2. The display controller circuit of claim 1 being a “fetch inhibiting” display controller, said display controller circuit further comprising an address counter for accessing said memory locations, wherein said memory fetches of subsequent memory locations are inhibited for a number of times equal to said repeat count, said address counter incrementing even when said memory fetches are inhibited.

3. The display controller circuit of claim 1 being a “memory saving” display controller, said display controller circuit further comprising an address counter for accessing said memory locations, wherein said pixel data is repeated for a number of times equal to said repeat count, said address counter only incrementing upon a memory fetch.

4. The display controller circuit of claim 1 further comprising:
(a) said memory depth being a 32-bits memory depth;
(b) said pixel data being RGB pixel data having a pixel data depth of 24-bits; and
(c) said repeat count being stored in 8 bits remaining in said display memory.

5. A memory control method that minimizes memory usage and/or power consumption, said memory control method comprising the steps of:
(a) providing a memory having a plurality of memory locations, each memory location having a memory depth, said memory depth divided into a data depth and an excess depth;
(b) storing at least one data having said data depth in said data depth of said memory;
(c) storing at least one repeat count using at least part of said excess depth of said memory;
(d) fetching said at least one data and an associated said at least one repeat count from one of said memory locations;
(e) displaying said at least one data on a display;
(f) repeating said step of displaying said at least one data on a display a number of times equal to said repeat count.

6. The memory control method of claim 5 being a “fetch inhibiting” memory control method further comprising the step of incrementing an address counter for accessing said memory locations for each step of (e) displaying and (f) repeating said step of displaying.

7. The memory control method of claim 5 being a “fetch inhibiting” memory control method further comprising the step of incrementing an address counter for accessing said memory locations every time said at least one data is displayed on said display.

8. The memory control method of claim 5 being a “memory saving” memory control method further comprising the step of incrementing an address counter for accessing said memory locations for each step of fetching.

9. The memory control method of claim 5 wherein said step of providing a memory having a plurality of memory locations further comprises the step of providing a memory having a plurality of memory locations, each memory location having a 32-bits memory depth, said memory depth divided into a 24-bits data depth and an 8 bit excess depth.

10. The memory control method of claim 5, wherein said step of repeating said step of displaying said at least one data on a display is repeated zero times if said repeat count equals zero.

11. A display system comprising:
(a) a display controller circuit;
(b) display memory having a plurality of memory locations, each memory location having a memory depth;
(c) a display device having a plurality of pixels;
(d) pixel data for defining/controlling said plurality of pixels, each pixel data having a pixel data depth, said pixel data depth being less than said memory depth, said pixel data stored in said display memory;
(e) repeat count having a repeat count depth, said repeat count depth being less than said memory depth, said repeat count stored in said display memory;
(f) wherein said repeat count represents the number of times an associated said pixel data is to be repeated for display on said display device.

12. The display system of claim 11 being a “fetch inhibiting” display system, said display system further comprising an address counter for accessing said memory locations, wherein said memory fetches of subsequent memory locations are inhibited for a number of times equal to said repeat count, said address counter incrementing even when said memory fetches are inhibited.

13. The display system of claim 11 being a “memory saving” display system, said display system further comprising an address counter for accessing said memory locations, wherein said pixel data is repeated for a number of times equal to said repeat count, said address counter only incrementing upon a memory fetch.

14. The display system of claim 11 further comprising:
(a) said memory depth being a 32-bits memory depth;
(b) said pixel data being RGB pixel data having a pixel data depth of 24-bits; and
(c) said repeat count being stored in 8 bits remaining in said display memory.

15. The display system of claim 11 wherein said display controller circuit, said display memory, and said display device are distinct units.

16. The display system of claim 11 wherein said display controller circuit, said display memory, and said display device are an integral unit.

17. The display system of claim 11 wherein said display controller circuit and said display memory are an integral unit, and said display device is an external display device.

18. A memory control system that minimizes memory usage and/or power consumption:
(a) memory having a plurality of memory locations, each memory location having a memory depth;
(b) data having a data depth, said data depth being less than said memory depth, said data stored in said memory;
(c) repeat count having a repeat count depth, said repeat count depth being less than said memory depth, said repeat count stored in said memory;
(d) wherein said repeat count is equal to 1+n times said data is to be used.

19. The memory control system of claim 18 being a “fetch inhibiting” memory control system, said memory control system further comprising an address counter for accessing said memory locations, wherein said address counter is incremented by 1+n for each fetch to said memory.

20. The memory control system of claim 18 being a “memory saving” memory control system, said memory control system further comprising an address counter for accessing said memory locations, wherein said address counter is incremented by 1 for each fetch to said memory.
